(19) United States
(12) Patent Application Publication
(10) Pub. No.: US 2025/0306908 A1
(43) Pub. Date: Oct. 2, 2025

(54) Apparatuses, Devices, Methods, and Computer Programs for a Computer System

(71) Applicant: Intel Corporation, Santa Clara, CA (US)

(72) Inventors: Xiang MA, Portland, OR (US); Curtis MACKAY, Boise, ID (US); Ravi POOVALUR RANGARAJAN, Hillsboro, OR (US); Amol SUKERKAR, Gilbert, AZ (US)

(21) Appl. No.: 19/237,074

(22) Filed: Jun. 13, 2025

Related U.S. Application Data
(63) Continuation of application No. 17/643,422, filed on Dec. 9, 2021.

(51) Int. Cl. G06F 8/65; H04L 67/00

(52) U.S. Cl. CPC G06F 8/65; H04L 67/34

(57) ABSTRACT

Various examples relate to apparatuses, devices, methods, and computer programs for a first computer system, and to computer systems comprising such apparatuses or devices. An apparatus for a first computer system comprises interface circuitry for communicating with one or more second computer systems and processing circuitry. The processing circuitry is configured to determine a status of a firmware of the first computer system, provide information on the status of the firmware to the one or more second computer systems, and obtain a response from at least one of the one or more second computer systems in response to the information on the status of the firmware.

### CROSS-REFERENCE TO RELATED APPLICATION

This application claims priority to U.S. patent application Ser. No. 17/643,422, filed on Dec. 9, 2021. The content of this earlier filed application is incorporated by reference.

### BACKGROUND

For systems that are in remote locations that are costly to physically access it is difficult to ensure that the firmware is up to date and healthy. While remote manageability features assist in firmware updates and resiliency features prevent firmware corruption, it is still possible for failures in both.

For example, the technique Download and Execute (DNX) may allow the system firmware to boot to a minimal state and then waits for the user to provide a new system firmware image to complete the boot process. However, it may require physical presence. The Intel® Active Management Technology (AMT) may enable an environment for users to manage systems remotely even if the systems are in a powered off state. It may be considered useful for mass management of systems even those that are off-site. However, system admins may be required to push the updates and deployment for each system. Embedded controllers (EC) may be used to control SPI (Serial Peripheral Interface) flash and may be used to provide out of band FW manageability. However, such embedded controllers may require additional hardware, and may be implementation specific.

### BRIEF DESCRIPTION OF THE FIGURES

Some examples of apparatuses and/or methods will be described in the following by way of example only, and with reference to the accompanying figures, in which

FIG. 1a shows a block diagram of an example of an apparatus or device for a first computer system;

FIGS. 1b and 1c show flow charts of examples of a method for a first computer system;

FIG. 1d shows a block diagram of another example of an apparatus or device for a first computer system;

FIG. 1e shows a flow chart of another example of a method for a first computer system;

FIGS. 2a and 2b show schematic illustrations of a concept for propagating firmware updates; and

FIGS. 3a to 3d show schematic illustrations of a concept for local peer-to-peer firmware recovery.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but embodiments of the technologies described herein may be practiced without these specific details. Well-known circuits, structures, and techniques have not been shown in detail to avoid obscuring an understanding of this description. “An embodiment/example,” “various embodiments/examples,” “some embodiments/examples,” and the like may include features, structures, or characteristics, but not every embodiment necessarily includes the particular features, structures, or characteristics.

Some embodiments may have some, all, or none of the features described for other embodiments. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an embodiment/example,” “in embodiments/examples,” “in some embodiments/examples,” and/or “in various embodiments/examples,” each of which may refer to one or more of the same or different embodiments. Furthermore, the terms “comprising,” “including,” “having,” and the like, as used with respect to embodiments of the present disclosure, are synonymous.

Various examples of the proposed concept relate to automatic firmware management over peer-to-peer networks. Using the proposed concept, (computer) systems on a local peer to peer network may manage firmware update amongst themselves, e.g. to propagate firmware updates and ensure all systems are on latest version and/or to provide self-healing capabilities for (computer) systems in remote locations.

In various examples, a peer-to-peer network of systems can be used to share and manage firmware updates and recovery. Systems can pull and push their status and firmware version to allow neighbors to act in case a system is out of date or in an unbootable state. For example, this may require no intervention from an administrator of the system.

Using the proposed concept, systems may propagate the latest firmware version without human intervention. It may be used to assure that all systems are on the same version of firmware (which may mitigate security vulnerabilities). Moreover, the proposed concept may be used to allow for automatic boot recovery without access to a manageability server.

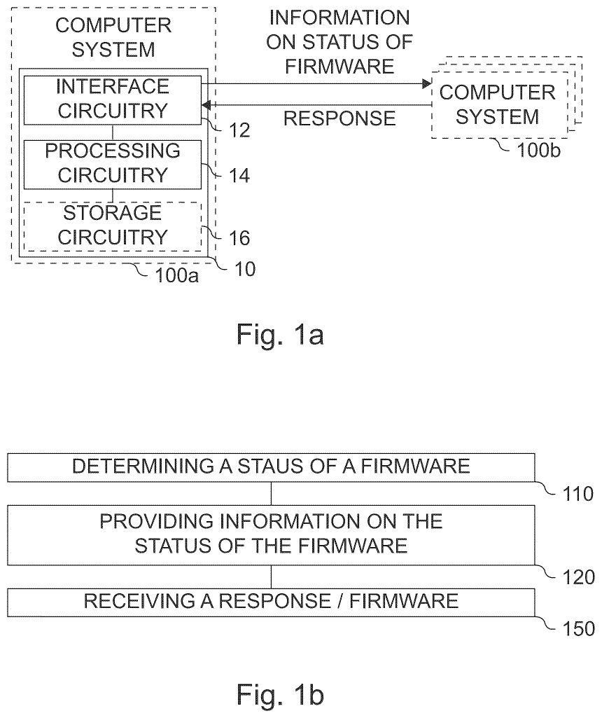

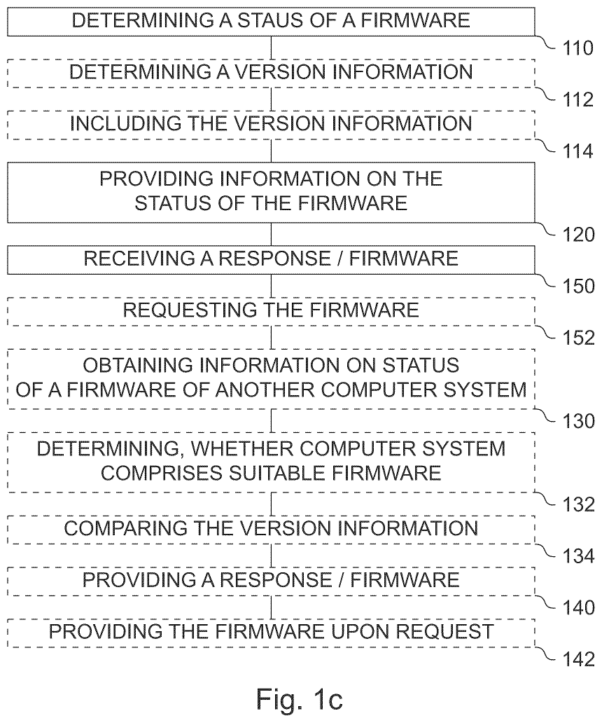

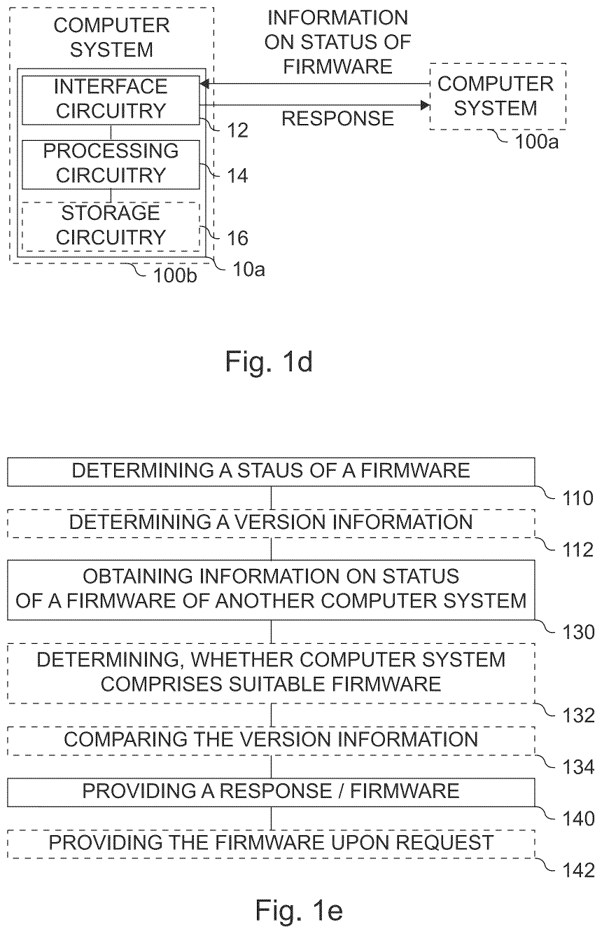

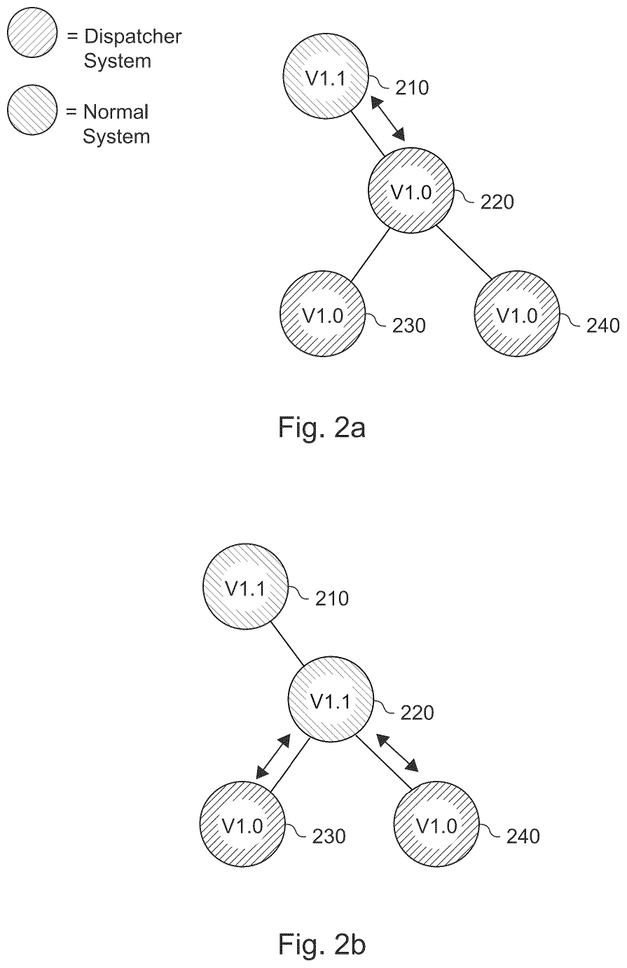

FIG. 1a shows a block diagram of an example of an apparatus 10 or device 10 for a first computer system. The apparatus 10 comprises circuitry that is configured to provide the functionality of the apparatus 10. For example, the apparatus 10 comprises interface circuitry 12, processing circuitry 14 and (optional) storage circuitry 16. For example, the processing circuitry 14 may be coupled with the interface circuitry 12 and with the storage circuitry 16. For example, the processing circuitry 14 may be configured to provide the functionality of the apparatus, in conjunction with the interface circuitry 12 (for exchanging information, e.g., with one or more second computer systems) and the storage circuitry (for storing information) 16. Likewise, the device may comprise means that is/are configured to provide the functionality of the device 10. The components of the device 10 are defined as component means, which may correspond to, or implemented by, the respective structural components of the apparatus 10. For example, the device 10 comprises means for processing 14, which may correspond to or be implemented by the processing circuitry 14, means for communicating 12, which may correspond to or be implemented by the interface circuitry 12, and (optional) means for storing information 16, which may correspond to or be implemented by the storage circuitry 16.

The interface circuitry 12/means for communication 12 is configured to communicate with one or more second computer systems 100b. The processing circuitry 14/means for processing 14 is configured to determine a status of a firmware of the first computer system. The processing circuitry 14/means for processing 14 is configured to provide (e.g., transmit) information on the status of the firmware to the one or more second computer systems. The processing circuitry 14/means for processing 14 is configured to obtain (e.g., receive) a response from at least one of the one or more second computer systems in response to the information on the status of the firmware.

FIG. 1a further shows a computer system, and in particular the first computer system 100a, comprising the apparatus 10 or device 10. In some examples, the one or more second computer systems 100b may also comprise the apparatus 10 or device 10. FIG. 1a further shows a system comprising a plurality of computer systems 100a; 100b, e.g., the first computer system 100a and the one or more second computer systems 100b.

FIGS. 1b and 1c show flow charts of examples of a corresponding method for the first computer system. The method comprises determining 110 the status of a firmware of the first computer system. The method comprises providing 120 the information on the status of the firmware to the one or more second computer systems. The method comprises obtaining 150 the response from at least one of the one or more second computer systems in response to the information on the status of the firmware. For example, the first computer system may execute the method.

In the following, the functionality of the apparatus 10, the device 10, the method and of a corresponding computer program is introduced in connection with the apparatus 10. Features introduced in connection with the apparatus 10 may be likewise included in the corresponding device 10, method and computer program.

As outlined above, the proposed concept provides a peer-to-peer concept for automatic firmware management, i.e., the first computer system and the one or more second computer systems communicate and manage their respective firmware among each other, e.g., without involving a central entity that centrally manages the firmware of the first computer system and of the one or more second computer systems. Accordingly, the first computer system, e.g., the interface circuitry, may be configured to communicate with the one or more second computer systems in peer-to-peer fashion, i.e., directly, without involving a central entity.

In general, the proposed concept may be used for at least two purposes'for automatic firmware propagation, where updated firmware is distributed in a peer-to-peer fashion, and for firmware recovery when a computer system ends up with a firmware that is unbootable, e.g., due to corruption of the firmware image. In both cases, the basis is the determination of the status of the firmware. For example, for the first purpose (automatic firmware propagation), the determination of the status of the firmware may comprise determining version information on the firmware of the first computer system. In other words, the processing circuitry may be configured to determine a version information on the firmware of the first computer system, and to include the version information in the information on the status of the firmware. Accordingly, as shown in FIG. 1c, the method may comprise determining 112 a version information on the firmware of the first computer system and including 114 the version information in the information on the status of the firmware. Accordingly, the information on the status of the firmware may comprise the version information.

For the second purpose (firmware recovery), determining the status of the firmware may comprise determining that the firmware is in an unbootable state, i.e., that the firmware cannot be used to boot the first computer system. For example, the processing circuitry may be configured to determine and provide information on the firmware being unbootable as part of the information on the status of the firmware if the firmware is determined to be unbootable. Accordingly, the method may comprise providing information on the firmware being unbootable as part of the information on the status of the firmware if the firmware is determined to be unbootable. Accordingly, the information on the status of the firmware may comprise the information on the firmware being unbootable. For example, the apparatus, device, method, and computer program may be implemented as part of a rescue firmware that is booted when the normal firmware (i.e., the firmware being used for normal operation) is unbootable.

Depending on the purpose, different operations may be taken. For the following examples, it may be assumed that the firmware of the first computer system is unbootable. In this case, the information on the status of the firmware being providing to the one or more second computer systems is used to inform the one or more second computer systems that the first computer system requires a replacement firmware to be provided by one of the one or more second computer systems. In this case, the response from the second system may be an offer for providing a suitable firmware. For example, the processing circuitry may be configured to obtain the suitable firmware for the first computer system from the second computer system providing the response. Accordingly,, as shown in FIG. 1c, the method may comprise obtaining 150; 152 a suitable firmware for the first computer system from the second computer system providing the response. In this context, a suitable firmware may be a firmware that can be used to operate the first computer system, e.g., a firmware that is compatible with the first computer system. While the firmware is obtained in a peer-to-peer fashion, in some cases, the firmware may be obtained from a network storage that is separate from the one or more second computer systems, with the response comprise locator information for accessing the firmware on the network storage.

The suitable firmware may be obtained by the first computer system based on the response, e.g., by contacting the second computer system and requesting the firmware from the second computer system, or by extracting the firmware from the response. For example, the response may comprise information on the second computer system offering to provide the suitable firmware for the first computer system. The processing circuitry may be configured to request the suitable firmware from the second computer system (or from a network storage) based on the response. Accordingly, as shown in FIG. 1c, the method may comprise requesting 152 the suitable firmware from the second computer system (or from a network storage) based on the response. In this case, the response may be considered as an offer to provide the suitable firmware. Alternatively, the response itself may comprise the suitable firmware.

For the purpose of distributing an updated firmware, a similar approach may be taken. In this case, it may be assumed that the firmware of the first computer system is at a lower version than the firmware of one of the one or more second computers. An updated version of the firmware (that is suitable for the first computer system) may be obtained (e.g., received) from the second computer system (or from a network storage). For example, the processing circuitry may be configured to obtain a firmware having an updated version for the first computer system from the second computer system providing the response (or from a network storage). Accordingly, the method may comprise obtaining a firmware having an updated version for the first computer system from the second computer system providing the response (or from a network storage).

Again, the suitable firmware may be obtained by the first computer system based on the response, e.g., by contacting the second computer system and requesting the firmware from the second computer system, or by extracting the firmware from the response. For example, the response may be obtained from at least one second computer system offering to provide the firmware having the updated version for the first computer system. The processing circuitry may be configured to request the firmware having the updated version from the second computer system based on the response. Accordingly, as shown in FIG. 1c, the method may comprise requesting 152 the firmware having the updated version from the second computer system based on the response. In this case, the response may be considered as an offer to provide the suitable firmware. Alternatively, the response itself may comprise the firmware having the updated version.

In some examples, the second computer system comprising the updated firmware may advertise the updated firmware among the other computer systems. For example, the processing circuitry may be configured to obtain a message indicating that a second computer system comprises the firmware with the updated version. In this case, the information on the status of the firmware may comprise a request for providing the firmware with the updated version.

As outlined above, the proposed concept is based on a peer-to-peer approach. Accordingly, the first computer system might not only be configured to obtain a firmware from the one or more second computer systems, but also to offer a firmware to the one or more computer systems. In this case, the reverse process may be used, where the first computer system receives the information on the status of a firmware from one of the one or more second computers, and offers a suitable firmware, if possible, to the second computer. For example, the processing circuitry may be configured to obtain information on the status of the firmware of the one or more second computer systems from the one or more second computer systems, and to provide a further response to the one or more second computer systems based on the status of the firmware of the first computer system and based on the information on the status of the firmware of the one or more second computer systems. Accordingly, as shown in FIG. 1c, the method may comprise obtaining 130 information on the status of the firmware of the one or more second computer systems from the one or more second computer systems and providing 140 a further response to the one or more second computer systems based on the status of the firmware of the first computer system and based on the information on the status of the firmware of the one or more second computer systems. This further response may comprise an offer to provide a suitable firmware, or the suitable firmware itself.

In case the first computer system acts as a provider of a suitable firmware, the first computer system might not be restricted to the firmware it is currently operating on. Instead, the first computer system may comprise a local (or remote) storage of firmware (images), which may be provided to the second computer. Accordingly, the first computer system may comprise a repository with a plurality of firmware images (or be connected to a repository with a plurality of firmware images hosted on a network storage). The processing circuitry may be configured to provide the further response to the one or more second computer systems based on the plurality of firmware images. Accordingly, the method may comprise providing the further response to the one or more second computer systems based on the plurality of firmware images. For example, the information on the status of the firmware may be determined based on the firmware images of the plurality of firmware images.

As outlined above, the proposed concept may be used for at least two purposes—for firmware recovery and for distribution of an updated firmware. In the following, the first purpose is discussed.

For example, the processing circuitry may be configured to determine, if the information on the status of the firmware of the one or more second computer systems indicates that the firmware of at least one second computer is determined to be unbootable, whether the first computer system (e.g., the repository or the firmware being used to operate the first computer system) comprises a firmware that is suitable for the at least one second computer, and to provide the suitable firmware to the at least one second computer if the first computer system comprises a firmware that is suitable for the at least one second computer system. Accordingly, as shown in FIG. 1c, the method may comprise determining 132, if the information on the status of the firmware of the one or more second computer systems indicates that the firmware of at least one second computer is determined to be unbootable, whether the first computer system comprises a firmware that is suitable for the at least one second computer, and providing 140; 142 the suitable firmware to the at least one second computer if the first computer system comprises a firmware that is suitable for the at least one second computer system. Again, “suitable” in this case indicates that the firmware is compatible with the at least one second computer system.

Similar to the process being used for the first computer system obtaining the suitable firmware image, the suitable firmware may be provided by the first computer system upon request by the at least one second computer system, or by including the suitable firmware in the further response. For example, the further response may comprise information on the first computer system offering to provide the suitable firmware for the at least one second computer system. The processing circuitry may be configured to provide the suitable firmware to the at least one second computer system upon request by the at least one second computer system. Accordingly, the method may comprise providing 142 the suitable firmware to the at least one second computer system upon request by the at least one second computer system. For example, the processing circuitry may be configured to obtain (e.g., receive) the request for the suitable firmware from the at least one second computer system, and to provide the suitable firmware in response to the request. Alternatively, the further response itself may comprise the suitable firmware.

The second purpose of distributing firmware images is illustrated in the following. Similar to the process of obtaining an updated firmware, the provision of the updated firmware is based on the version information of the respective firmware. Accordingly, the processing circuitry may be configured to determine a version information on the firmware (e.g., on the plurality of firmware images) of the first computer system. The processing circuitry may be configured to compare the version information on the firmware of the first computer system with version information included in the information on the status of the firmware of the one or more second computer systems. Accordingly, the method may comprise determining a version information 112 on the firmware of the first computer system. The method may comprise comparing 134 the version information on the firmware of the first computer system with version information included in the information on the status of the firmware of the one or more second computer systems. This comparison may be used to determine, whether the first computer system comprises a firmware (e.g., the firmware being used to operate the first computer system, or the plurality of firmware images stored in the repository) with an updated version relative version information included in the information on the status of the firmware of at least one of the one or more second computer systems, i.e., whether the first computer system comprises a firmware that is newer (i.e., is updated relative to another firmware being used by a second computer), and that is compatible with the respective second computer system. For example, the processing circuitry may be configured to, if the first computer system comprises a firmware with an updated version relative to the version information included in the information on the status of the firmware of at least one of the one or more second computer systems, provide the firmware having the updated version to the at least one second computer system. Accordingly, the method may comprise, if the first computer system comprises a firmware with an updated version relative to the version information included in the information on the status of the firmware of at least one of the one or more second computer systems, providing 140; 142 the firmware having the updated version to the at least one second computer system.

Similar to the process being used for the first computer system obtaining the updated firmware, the updated firmware may be provided by the first computer system upon request by the at least one second computer system, or by including the updated firmware in the further response. For example, the further response may comprise an offer to provide the firmware having the updated version to the at least one second computer system. The processing circuitry may be configured to provide the firmware having the updated version upon request by the at least one second computer system. Accordingly, the method may comprise providing 142 the firmware having the updated version upon request by the at least one second computer system. For example, the processing circuitry may be configured to obtain (e.g., receive) the request for the updated firmware from the at least one second computer system, and to provide the updated firmware in response to the request. Alternatively, the further response itself may comprise the updated firmware, i.e., the firmware having the updated version.

In some examples, after the first computer system is updated with an updated firmware, it may advertise the updated firmware among the other computer systems. For example, the processing circuitry may be configured to provide a message indicating that the first computer system comprises the firmware with the updated version. For example, the information on the status of the firmware may comprise a notification that the first computer system comprises a firmware having an updated version.

In general, the firmware may comprise or correspond to a basic system of the first and second computer system, e.g., a Basic Input Output System (BIOS) firmware or a Unified Extensible Firmware Interface (UEFI) firmware. In some examples, the firmware of the computer system may comprise an operating system of the first and second computer system, e.g., an operating system image. The firmware may be provided and obtained in form of a firmware image that can be used as drop-in replacement firmware for the respective computer system, or that can be used to overwrite the firmware of the respective computer system

For example, the first and second computer systems may be personal computer systems, such as a desktop computer or laptop computer, or server computer systems. In particular, the first and second computer systems may be server computer systems located in a (remote) server farm. In some examples, the computer systems may be mobile computer systems, such as smartphones or tablet computers.

The interface circuitry 12 or means for communicating 12 of FIGS. 1a (and FIG. 1d introduced in the following) may correspond to one or more inputs and/or outputs for receiving and/or transmitting information, which may be in digital (bit) values according to a specified code, within a module, between modules or between modules of different entities. For example, the interface circuitry 12 or means for communicating 12 may comprise circuitry configured to receive and/or transmit information.

For example, the processing circuitry 14 or means for processing 14 of FIGS. 1a and 1d may be implemented using one or more processing units, one or more processing devices, any means for processing, such as a processor, a computer or a programmable hardware component being operable with accordingly adapted software. In other words, the described function of the processing circuitry 14 or means for processing may as well be implemented in software, which is then executed on one or more programmable hardware components. Such hardware components may comprise a general purpose processor, a Digital Signal Processor (DSP), a micro-controller, etc.

For example, the storage circuitry 16 or means for storing information 16 of FIGS. 1a and 1d may comprise at least one element of the group of a computer readable storage medium, such as a magnetic or optical storage medium, e.g. a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

More details and aspects of the apparatus, device, method, computer program and computer systems are mentioned in connection with the proposed concept or one or more examples described above or below (e.g. FIGS. 1d to 3d). The apparatus, device, method, computer program and computer systems may comprise one or more additional optional features corresponding to one or more aspects of the proposed concept or one or more examples described above or below.

In some examples of the apparatus, device, method, computer program and computer systems, the first computer system may act as both a receiver and provider of firmware from and for the one or more second computer systems. However, in some examples, the first computer system might act only as provider. Such an example is shown in connection with FIGS. 1d to 1e. The apparatus, device, method, computer program and computer systems of FIGS. 1d and 1e may be implemented similar to the apparatus, device, method, computer program and computer systems of FIGS. 1a to 1c, with a focus on the distributing of firmware.

FIG. 1d shows a block diagram of another example of an apparatus 10a or device 10a for a first computer system. The apparatus 10a comprises circuitry that is configured to provide the functionality of the apparatus 10a. For example, the apparatus 10a comprises interface circuitry 12, processing circuitry 14 and (optional) storage circuitry 16. For example, the processing circuitry 14 may be coupled with the interface circuitry 12 and with the storage circuitry 16. For example, the processing circuitry 14 may be configured to provide the functionality of the apparatus, in conjunction with the interface circuitry 12 (for exchanging information, e.g., with one or more second computer systems) and the storage circuitry (for storing information) 16. Likewise, the device may comprise means that is/are configured to provide the functionality of the device 10a. The components of the device 10a are defined as component means, which may correspond to, or implemented by, the respective structural components of the apparatus 10. For example, the device 10 comprises means for processing 14, which may correspond to or be implemented by the processing circuitry 14, means for communicating 12, which may correspond to or be implemented by the interface circuitry 12, and (optional) means for storing information 16, which may correspond to or be implemented by the storage circuitry 16.

The interface circuitry 12/means for communication 12 is configured to communicate with one or more second computer systems. The processing circuitry 14 or means for processing 14 is configured to determine a status of a firmware of the first computer system. The processing circuitry 14 or means for processing 14 is configured to obtain (e.g., receive) information on the status of the firmware of the one or more second computer systems from the one or more second computer systems. The processing circuitry 14 or means for processing 14 is configured to provide (e.g., transmit) a response to the one or more second computer systems based on the status of the firmware of the first computer system and based on the information on the status of the firmware of the one or more second computer systems. For example, the response may correspond to the further response provided by the apparatus or device 10 of FIG. 1a.

FIG. 1d further shows a computer system, and in particular the first computer system 100b, comprising the apparatus 10a or device 10a. As is evident, in this case, the role of the first and second computer system may be reversed relative to the examples shown in connection with FIGS. 1a to 1c. In some examples, the one or more second computer systems 100a may comprise the apparatus 10 or device 10 of FIG. 1a. FIG. 1d further shows a system comprising a plurality of computer systems 100a; 100b, e.g., the first computer system 100b and one or more second computer systems 100a.

FIG. 1e shows a flow chart of another example of a corresponding method for a first computer system. The method comprises determining 110 a status of a firmware of the first computer system. The method comprises obtaining 130 information on the status of the firmware of the one or more second computer systems from the one or more second computer systems. The method comprises providing 140 a response to the one or more second computer systems based on the status of the firmware of the first computer system and based on the information on the status of the firmware of the one or more second computer systems. For example, the method may be executed by the first computer system, e.g., by the apparatus or device of the first computer system.

In the following, the functionality of the apparatus 10a, the device 10a, the method and of a corresponding computer program is introduced in connection with the apparatus 10a. Features introduced in connection with the apparatus 10a may be likewise included in the corresponding device 10a, method and computer program.

In the examples given with respect to FIGS. 1d and 1e, the first computer system is used as provider for suitable and/or updated firmware for the one or more second computer systems. Accordingly, it obtains the information on the status of the firmware of the one or more second computer systems from the one or more second computer systems. This information may be used to determine, which of the one or more second benefits require a suitable firmware (in case the respective second computer system is unbootable) or an updated firmware (in case the first computer system comprises a firmware with a newer/higher version information).

As outlined with respect to some examples of FIGS. 1a to 1c, when the first computer system acts as a provider of a suitable firmware, the first computer system might not be restricted to the firmware it is currently operating on. Instead, the first computer system may comprise a local (or remote) storage of firmware (images), which may be provided to the second computer. Accordingly, the first computer system may comprise a repository with a plurality of firmware images (or be connected to a repository with a plurality of firmware images hosted on a network storage). The processing circuitry may be configured to provide the further response to the one or more second computer systems based on the plurality of firmware images. Accordingly, the method may comprise providing the further response to the one or more second computer systems based on the plurality of firmware images. For example, the information on the status of the firmware may be determined based on the firmware images of the plurality of firmware images.

In the following, some examples relate to the first purpose (providing a suitable firmware to a second computer system with an unbootable firmware). For example, the processing circuitry may be configured to determine, if the information on the status of the firmware of the one or more second computer systems indicates that the firmware of at least one second computer is determined to be unbootable, whether the first computer system (e.g., the repository or the firmware being used to operate the first computer system) comprises a firmware that is suitable for the at least one second computer, and to provide the suitable firmware to the at least one second computer if the first computer system comprises a firmware that is suitable for the at least one second computer system. Accordingly, the method may comprise determining 132, if the information on the status of the firmware of the one or more second computer systems indicates that the firmware of at least one second computer is determined to be unbootable, whether the first computer system comprises a firmware that is suitable for the at least one second computer, and providing 140; 142 the suitable firmware to the at least one second computer if the first computer system comprises a firmware that is suitable for the at least one second computer system.

For example, the suitable firmware may be provided by the first computer system upon request by the at least one second computer system, or by including the suitable firmware in the response. For example, the response may comprise information on the first computer system offering to provide the suitable firmware for the at least one second computer system. The processing circuitry may be configured to provide the suitable firmware to the at least one second computer system upon request by the at least one second computer system. Accordingly, the method may comprise providing 142 the suitable firmware to the at least one second computer system upon request by the at least one second computer system. For example, the processing circuitry may be configured to obtain (e.g., receive) the request for the suitable firmware from the at least one second computer system, and to provide the suitable firmware in response to the request. Alternatively, the response itself may comprise the suitable firmware.

The second purpose of distributing firmware images is illustrated in the following. For example, the provision of the updated firmware may be based on the version information of the respective firmware. Accordingly, the processing circuitry may be configured to determine a version information on the firmware (e.g., on the plurality of firmware images) of the first computer system. The processing circuitry may be configured to compare the version information on the firmware of the first computer system with version information included in the information on the status of the firmware of the one or more second computer systems. Accordingly, the method may comprise determining a version information 112 on the firmware of the first computer system. The method may comprise comparing 134 the version information on the firmware of the first computer system with version information included in the information on the status of the firmware of the one or more second computer systems. This comparison may be used to determine, whether the first computer system comprises a firmware (e.g., the firmware being used to operate the first computer system, or the plurality of firmware images stored in the repository) with an updated version relative version information included in the information on the status of the firmware of at least one of the one or more second computer systems, i.e., whether the first computer system comprises a firmware that is newer (i.e., is updated relative to another firmware being used by a second computer), and that is compatible with the respective second computer system. For example, the processing circuitry may be configured to, if the first computer system comprises a firmware with an updated version relative to the version information included in the information on the status of the firmware of at least one of the one or more second computer systems, provide the firmware having the updated version to the at least one second computer system. Accordingly, the method may comprise, if the first computer system comprises a firmware with an updated version relative to the version information included in the information on the status of the firmware of at least one of the one or more second computer systems, providing 140; 142 the firmware having the updated version to the at least one second computer system.

As described in connection with FIGS. 1a to 1c, the updated firmware may be provided by the first computer system upon request by the at least one second computer system, or by including the updated firmware in the response. For example, the further response may comprise an offer to provide the firmware having the updated version to the at least one second computer system. The processing circuitry may be configured to provide the firmware having the updated version upon request by the at least one second computer system. Accordingly, the method may comprise providing 142 the firmware having the updated version upon request by the at least one second computer system. For example, the processing circuitry may be configured to obtain (e.g., receive) the request for the updated firmware from the at least one second computer system, and to provide the updated firmware in response to the request. Alternatively, the response itself may comprise the updated firmware, i.e., the firmware having the updated version.

More details and aspects of the apparatus, device, method, computer program and computer systems are mentioned in connection with the proposed concept or one or more examples described above or below (e.g. FIG. 1a to 1c, 2a to 3d). The apparatus, device, method, computer program and computer systems may comprise one or more additional optional features corresponding to one or more aspects of the proposed concept or one or more examples described above or below.

In the following, two examples of applications of the proposed concept are shown.

For example, a local network of systems (i.e., the first and second computer systems) can use each other to request and deliver firmware updates. The network can be any local communication method between systems, such as low-level wire communication (serial/I2C (Inter-Integrated Circuit), Bluetooth, TCP/IP (Transmission Control Protocol/Internet Protocol), etc. In other words, the first and second computer systems introduced in connection with FIGS. 1a to 1e may communicate using low-level wire communication, Bluetooth, TCP/IP, and the like. The network may also be distributed, as the proposed concept might not require internet access or a centralized controller system, i.e. it operates in peer-to-peer fashion. The proposed concept may allow users to propagate firmware updates locally between systems connected on the local network and/or to provide automatic local firmware recovery.

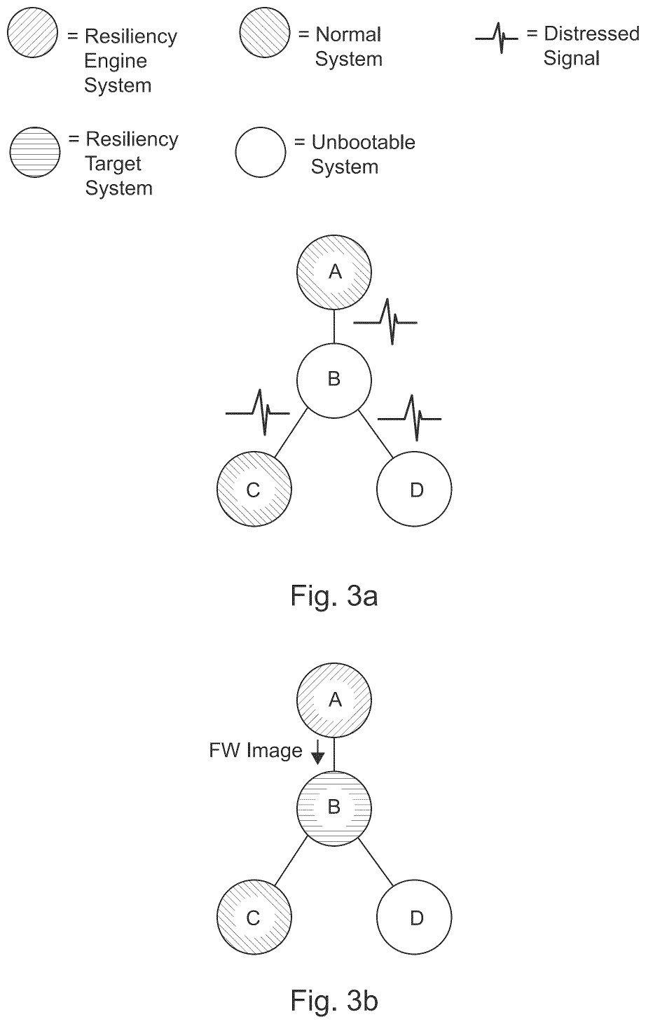

In the following, an example is given with respect to propagating firmware updates. For example, when a single system's firmware is updated, the system may take on the role as a dispatcher (see (computer) system 210 of FIG. 2a). The dispatcher may query neighboring systems firmware version to check if the firmware should be propagated to neighboring systems (e.g., using the information on the status of the firmware comprising version information). The dispatcher may forward its firmware image to its neighbors that are on a lower version of firmware. The dispatcher may then return to normal operation. Accordingly, the dispatcher's role may be to query neighbor system's firmware versions after a firmware update, and to send the firmware image to out of date systems. For example, the dispatcher system and the neighboring systems may be implemented similar to the apparatus, device, and computer system of FIGS. 1a or 1d.

FIGS. 2a and 2b show schematic illustrations of the concept for propagating firmware updates. In FIG. 2a, the dispatcher system 210 with FW (Firmware) version 1.1 queries neighboring system's 220 FW (which is at version 1.0). The dispatcher may then forward the latest FW version to its neighbors for updates. In FIG. 2b, the obtaining system 220 updates to FW version 1.1, and propagates the FW image to its neighbors 230-240.

Another example relates to local Peer-to-Peer (P2P) firmware recovery. When a system gets in an unbootable state, it may boot to a P2P Recovery boot image. On the next boot, it may become a resiliency target system (RTS) and broadcast a distressed signal (e.g., the information on the status of the firmware comprising information on the firmware being unbootable). Neighboring systems may respond to the distress signal, and the first responder may set a up handshake with the RTS to form a link for recovery. The responding system may become a resiliency engine system (RES) and send a firmware image to the RTS for recovery. The FW image may come local from the RES or over a network. The distressed system may obtain the firmware image and update itself to recover. The recovered system may then check neighboring systems whether they are unbootable, and the process may repeat. Thus, multiple systems may be recovered in a recursive fashion.

Accordingly, the resiliency target system may detect an unbootable state and send a distress signal, confirm a handshake with the first responding system to set up recovery link, and obtain the recovery system FW image. The resiliency engine system may respond do the distressed System and establishes handshake, detect distressed system FW requirements, retrieve a corresponding FW image, and/or forward the firmware image to the distressed system.

For example, the resiliency target system, the resiliency engine system, the normal system and/or the system in an unbootable state be implemented similar to the apparatus, device, and computer system of FIGS. 1a or 1d.

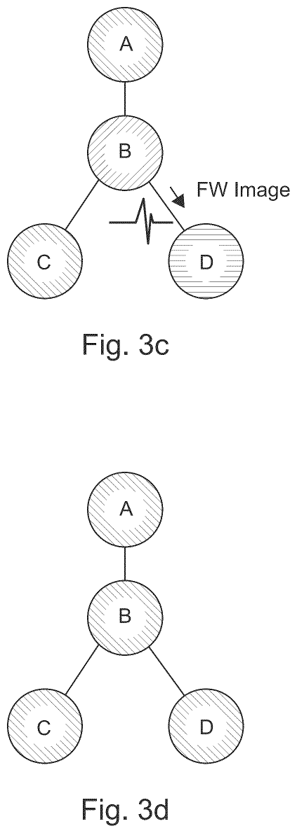

FIGS. 3a to 3d show schematic illustrations of a concept for local peer-to-peer firmware recovery. In FIG. 3a System B and D are unbootable, while systems A and C are in a normal state. The unbootable systems B and D send out a distress signal to neighboring systems A and C. As shown in FIG. 3b, system A responds to System B first. It establishes a resiliency engine system (system A) to resiliency target system (system B) relationship. System A sends a FW image to System B. As shown in FIG. 3c, system B recovers, and then responds to System D. Establishes a new resiliency engine system (system B) to resiliency target system (system D) relationship and sends a FW image. In FIG. 3d, all systems are recovered and functioning normally.

More details and aspects of the examples are mentioned in connection with the proposed concept or one or more examples described above or below (e.g. FIG. 1a to 1e). The examples may comprise one or more additional optional features corresponding to one or more aspects of the proposed concept or one or more examples described above or below.

The aspects and features described in relation to a particular one of the previous examples may also be combined with one or more of the further examples to replace an identical or similar feature of that further example or to additionally introduce the features into the further example.

In the following, some examples are presented:

An example (e.g., example 1) relates to an apparatus (10) for a first computer system (100a), the apparatus (10) comprising interface circuitry (12) for communicating with one or more second computer systems (100b). The apparatus (10) comprises processing circuitry (14) configured to determine a status of a firmware of the first computer system, provide information on the status of the firmware to the one or more second computer systems, and obtain a response from at least one of the one or more second computer systems in response to the information on the status of the firmware.

Another example (e.g., example 2) relates to a previously described example (e.g., example 1) or to any of the examples described herein, further comprising that the processing circuitry is configured to provide information on the firmware being unbootable as part of the information on the status of the firmware if the firmware is determined to be unbootable.

Another example (e.g., example 3) relates to a previously described example (e.g., example 2) or to any of the examples described herein, further comprising that the processing circuitry is configured to obtain a suitable firmware for the first computer system from the second computer system providing the response.

Another example (e.g., example 4) relates to a previously described example (e.g., example 3) or to any of the examples described herein, further comprising that the response comprises information on the second computer system offering to provide the suitable firmware for the first computer system, wherein the processing circuitry is configured to request the suitable firmware from the second computer system based on the response.

Another example (e.g., example 5) relates to a previously described example (e.g., example 3) or to any of the examples described herein, further comprising that the response comprises the suitable firmware.

Another example (e.g., example 6) relates to a previously described example (e.g., one of the examples 1 to 5) or to any of the examples described herein, further comprising that the processing circuitry is configured to determine a version information on the firmware of the first computer system, and to include the version information in the information on the status of the firmware.

Another example (e.g., example 7) relates to a previously described example (e.g., example 6) or to any of the examples described herein, further comprising that the processing circuitry is configured to obtain a firmware having an updated version for the first computer system from the second computer system providing the response.

Another example (e.g., example 8) relates to a previously described example (e.g., example 7) or to any of the examples described herein, further comprising that the response is obtained from at least one second computer system offering to provide the firmware having the updated version for the first computer system, wherein the processing circuitry is configured to request the firmware having the updated version from the second computer system based on the response

Another example (e.g., example 9) relates to a previously described example (e.g., example 7) or to any of the examples described herein, further comprising that the response comprises the firmware having the updated version.

Another example (e.g., example 10) relates to a previously described example (e.g., one of the examples 1 to 9) or to any of the examples described herein, further comprising that the processing circuitry is configured to obtain information on the status of the firmware of the one or more second computer systems from the one or more second computer systems, and to provide a further response to the one or more second computer systems based on the status of the firmware of the first computer system and based on the information on the status of the firmware of the one or more second computer systems.

Another example (e.g., example 11) relates to a previously described example (e.g., example 10) or to any of the examples described herein, further comprising that the processing circuitry is configured to determine, if the information on the status of the firmware of the one or more second computer systems indicates that the firmware of at least one second computer is determined to be unbootable, whether the first computer system comprises a firmware that is suitable for the at least one second computer, and to provide the suitable firmware to the at least one second computer if the first computer system comprises a firmware that is suitable for the at least one second computer system.

Another example (e.g., example 12) relates to a previously described example (e.g., example 11) or to any of the examples described herein, further comprising that the further response comprises information on the first computer system offering to provide the suitable firmware for the at least one second computer system, wherein the processing circuitry is configured to provide the suitable firmware to the at least one second computer system upon request by the at least one second computer system.

Another example (e.g., example 13) relates to a previously described example (e.g., example 11) or to any of the examples described herein, further comprising that the further response comprises the suitable firmware.

Another example (e.g., example 14) relates to a previously described example (e.g., one of the examples 10 to 13) or to any of the examples described herein, further comprising that the processing circuitry is configured to determine a version information on the firmware of the first computer system, and to compare the version information on the firmware of the first computer system with version information included in the information on the status of the firmware of the one or more second computer systems.

Another example (e.g., example 15) relates to a previously described example (e.g., example 14) or to any of the examples described herein, further comprising that the processing circuitry is configured to, if the first computer system comprises a firmware with an updated version relative to the version information included in the information on the status of the firmware of at least one of the one or more second computer systems, provide the firmware having the updated version to the at least one second computer system.

Another example (e.g., example 16) relates to a previously described example (e.g., example 15) or to any of the examples described herein, further comprising that the further response comprises an offer to provide the firmware having the updated version to the at least one second computer system, and the processing circuitry is configured to provide the firmware having the updated version upon request by the at least one second computer system.

Another example (e.g., example 17) relates to a previously described example (e.g., example 15) or to any of the examples described herein, further comprising that the further response comprises the firmware having the updated version.

Another example (e.g., example 18) relates to a previously described example (e.g., one of the examples 10 to 17) or to any of the examples described herein, further comprising that the first computer system comprises a repository with a plurality of firmware images, wherein the processing circuitry is configured to provide the further response to the one or more second computer systems based on the plurality of firmware images.

Another example (e.g., example 19) relates to a previously described example (e.g., one of the examples 1 to 18) or to any of the examples described herein, further comprising that the first computer system is configured to communicate with the one or more second computer systems in peer-to-peer fashion.

An example (e.g., example 20) relates to a computer system comprising the apparatus according to one of the examples 1 to 19.

An example (e.g., example 21) relates to a system comprising a plurality of computer systems according to example 20.

An example (e.g., example 22) relates to an apparatus (10a) for a first computer system, the apparatus comprising interface circuitry (12) for communicating with one or more second computer systems. The apparatus (10a) comprises processing circuitry (14) configured to determine a status of a firmware of the first computer system, obtain information on the status of the firmware of the one or more second computer systems from the one or more second computer systems, and provide a response to the one or more second computer systems based on the status of the firmware of the first computer system and based on the information on the status of the firmware of the one or more second computer systems.

Another example (e.g., example 23) relates to a previously described example (e.g., example 22) or to any of the examples described herein, further comprising that the processing circuitry is configured to determine, if the information on the status of the firmware of the one or more second computer systems indicates that the firmware of at least one second computer is determined to be unbootable, whether the first computer system comprises a firmware that is suitable for the at least one second computer, and to provide the suitable firmware to the at least one second computer if the first computer system comprises a firmware that is suitable for the at least one second computer system.

Another example (e.g., example 24) relates to a previously described example (e.g., example 23) or to any of the examples described herein, further comprising that the response comprises information on the first computer system offering to provide the suitable firmware for the at least one second computer system, wherein the processing circuitry is configured to provide the suitable firmware to the at least one second computer system upon request by the at least one second computer system.

Another example (e.g., example 25) relates to a previously described example (e.g., example 23) or to any of the examples described herein, further comprising that the response comprises the suitable firmware.

Another example (e.g., example 26) relates to a previously described example (e.g., one of the examples 22 to 25) or to any of the examples described herein, further comprising that the processing circuitry is configured to determine a version information on the firmware of the first computer system, and to compare the version information on the firmware of the first computer system with version information included in the information on the status of the firmware of the one or more second computer systems.

Another example (e.g., example 27) relates to a previously described example (e.g., example 26) or to any of the examples described herein, further comprising that the processing circuitry is configured to, if the first computer system comprises a firmware with an updated version relative to the version information included in the information on the status of the firmware of at least one of the one or more second computer systems, provide the firmware having the updated version to the at least one second computer system.

Another example (e.g., example 28) relates to a previously described example (e.g., example 27) or to any of the examples described herein, further comprising that the response comprises an offer to provide the firmware having the updated version to the at least one second computer system, and the processing circuitry is configured to provide the firmware having the updated version upon request by the at least one second computer system.

Another example (e.g., example 29) relates to a previously described example (e.g., example 27) or to any of the examples described herein, further comprising that the response comprises the firmware having the updated version.

Another example (e.g., example 30) relates to a previously described example (e.g., one of the examples 22 to 29) or to any of the examples described herein, further comprising that the first computer system comprises a repository with a plurality of firmware images, wherein the processing circuitry is configured to provide the response to the one or more second computer systems based on the plurality of firmware images.

Another example (e.g., example 31) relates to a previously described example (e.g., one of the examples 22 to 30) or to any of the examples described herein, further comprising that the first computer system is configured to communicate with the one or more second computer systems in peer-to-peer fashion.

An example (e.g., example 32) relates to a computer system (100b) comprising the apparatus (10a) according to one of the examples 22 to 31.

An example (e.g., example 33) relates to a device (10) for a first computer system (100a), the device (10) comprising means for communicating (12) for communicating with one or more second computer systems (100b). The device (10) comprises means for processing (14) configured to determine a status of a firmware of the first computer system, provide information on the status of the firmware to the one or more second computer systems, and obtain a response from at least one of the one or more second computer systems in response to the information on the status of the firmware.

Another example (e.g., example 34) relates to a previously described example (e.g., example 33) or to any of the examples described herein, further comprising that the means for processing is configured to provide information on the firmware being unbootable as part of the information on the status of the firmware if the firmware is determined to be unbootable.

Another example (e.g., example 35) relates to a previously described example (e.g., example 34) or to any of the examples described herein, further comprising that the means for processing is configured to obtain a suitable firmware for the first computer system from the second computer system providing the response.

Another example (e.g., example 36) relates to a previously described example (e.g., example 35) or to any of the examples described herein, further comprising that the response comprises information on the second computer system offering to provide the suitable firmware for the first computer system, wherein the means for processing is configured to request the suitable firmware from the second computer system based on the response.

Another example (e.g., example 37) relates to a previously described example (e.g., example 35) or to any of the examples described herein, further comprising that the response comprises the suitable firmware.

Another example (e.g., example 38) relates to a previously described example (e.g., one of the examples 33 to 37) or to any of the examples described herein, further comprising that the means for processing is configured to determine a version information on the firmware of the first computer system, and to include the version information in the information on the status of the firmware.

Another example (e.g., example 39) relates to a previously described example (e.g., example 38) or to any of the examples described herein, further comprising that he means for processing is configured to obtain a firmware having an updated version for the first computer system from the second computer system providing the response.

Another example (e.g., example 40) relates to a previously described example (e.g., example 39) or to any of the examples described herein, further comprising that the response is obtained from at least one second computer system offering to provide the firmware having the updated version for the first computer system, wherein the means for processing is configured to request the firmware having the updated version from the second computer system based on the response

Another example (e.g., example 41) relates to a previously described example (e.g., example 39) or to any of the examples described herein, further comprising that the response comprises the firmware having the updated version.

Another example (e.g., example 42) relates to a previously described example (e.g., one of the examples 33 to 41) or to any of the examples described herein, further comprising that the means for processing is configured to obtain information on the status of the firmware of the one or more second computer systems from the one or more second computer systems, and to provide a further response to the one or more second computer systems based on the status of the firmware of the first computer system and based on the information on the status of the firmware of the one or more second computer systems.

Another example (e.g., example 43) relates to a previously described example (e.g., example 42) or to any of the examples described herein, further comprising that the means for processing is configured to determine, if the information on the status of the firmware of the one or more second computer systems indicates that the firmware of at least one second computer is determined to be unbootable, whether the first computer system comprises a firmware that is suitable for the at least one second computer, and to provide the suitable firmware to the at least one second computer if the first computer system comprises a firmware that is suitable for the at least one second computer system.

Another example (e.g., example 44) relates to a previously described example (e.g., example 43) or to any of the examples described herein, further comprising that the further response comprises information on the first computer system offering to provide the suitable firmware for the at least one second computer system, wherein the means for processing is configured to provide the suitable firmware to the at least one second computer system upon request by the at least one second computer system.

Another example (e.g., example 45) relates to a previously described example (e.g., example 43) or to any of the examples described herein, further comprising that the further response comprises the suitable firmware.

Another example (e.g., example 46) relates to a previously described example (e.g., one of the examples 42 to 45) or to any of the examples described herein, further comprising that the means for processing is configured to determine a version information on the firmware of the first computer system, and to compare the version information on the firmware of the first computer system with version information included in the information on the status of the firmware of the one or more second computer systems.

Another example (e.g., example 47) relates to a previously described example (e.g., example 46) or to any of the examples described herein, further comprising that the means for processing is configured to, if the first computer system comprises a firmware with an updated version relative to the version information included in the information on the status of the firmware of at least one of the one or more second computer systems, provide the firmware having the updated version to the at least one second computer system.

Another example (e.g., example 48) relates to a previously described example (e.g., example 47) or to any of the examples described herein, further comprising that the further response comprises an offer to provide the firmware having the updated version to the at least one second computer system, and the means for processing is configured to provide the firmware having the updated version upon request by the at least one second computer system.

Another example (e.g., example 49) relates to a previously described example (e.g., example 47) or to any of the examples described herein, further comprising that the further response comprises the firmware having the updated version.

Another example (e.g., example 50) relates to a previously described example (e.g., one of the examples 42 to 49) or to any of the examples described herein, further comprising that the first computer system comprises a repository with a plurality of firmware images, wherein the means for processing is configured to provide the further response to the one or more second computer systems based on the plurality of firmware images.

Another example (e.g., example 51) relates to a previously described example (e.g., one of the examples 33 to 48) or to any of the examples described herein, further comprising that the first computer system is configured to communicate with the one or more second computer systems in peer-to-peer fashion.

An example (e.g., example 52) relates to a computer system (100a; 100b) comprising the device according to one of the examples 33 to 51.

An example (e.g., example 53) relates to a system comprising a plurality of computer systems (100a; 100b) according to example 52.

An example (e.g., example 54) relates to a device (10a) for a first computer system, the device comprising means for communicating (12) for communicating with one or more second computer systems (100b). The device (10a) comprises means for processing (14) configured to determine a status of a firmware of the first computer system, obtain information on the status of the firmware of the one or more second computer systems from the one or more second computer systems, and provide a response to the one or more second computer systems based on the status of the firmware of the first computer system and based on the information on the status of the firmware of the one or more second computer systems.

Another example (e.g., example 55) relates to a previously described example (e.g., example 54) or to any of the examples described herein, further comprising that the means for processing is configured to determine, if the information on the status of the firmware of the one or more second computer systems indicates that the firmware of at least one second computer is determined to be unbootable, whether the first computer system comprises a firmware that is suitable for the at least one second computer, and to provide the suitable firmware to the at least one second computer if the first computer system comprises a firmware that is suitable for the at least one second computer system.

Another example (e.g., example 56) relates to a previously described example (e.g., example 55) or to any of the examples described herein, further comprising that the response comprises information on the first computer system offering to provide the suitable firmware for the at least one second computer system, wherein the means for processing is configured to provide the suitable firmware to the at least one second computer system upon request by the at least one second computer system.

Another example (e.g., example 57) relates to a previously described example (e.g., example 55) or to any of the examples described herein, further comprising that the response comprises the suitable firmware.

Another example (e.g., example 58) relates to a previously described example (e.g., one of the examples 54 to 57) or to any of the examples described herein, further comprising that the means for processing is configured to determine a version information on the firmware of the first computer system, and to compare the version information on the firmware of the first computer system with version information included in the information on the status of the firmware of the one or more second computer systems.

Another example (e.g., example 59) relates to a previously described example (e.g., example 58) or to any of the examples described herein, further comprising that the means for processing is configured to, if the first computer system comprises a firmware with an updated version relative to the version information included in the information on the status of the firmware of at least one of the one or more second computer systems, provide the firmware having the updated version to the at least one second computer system.

Another example (e.g., example 60) relates to a previously described example (e.g., example 59) or to any of the examples described herein, further comprising that the response comprises an offer to provide the firmware having the updated version to the at least one second computer system, and the means for processing is configured to provide the firmware having the updated version upon request by the at least one second computer system.

Another example (e.g., example 61) relates to a previously described example (e.g., example 59) or to any of the examples described herein, further comprising that the response comprises the firmware having the updated version.

Another example (e.g., example 62) relates to a previously described example (e.g., one of the examples 54 to 61) or to any of the examples described herein, further comprising that the first computer system comprises a repository with a plurality of firmware images, wherein the means for processing is configured to provide the response to the one or more second computer systems based on the plurality of firmware images.

Another example (e.g., example 63) relates to a previously described example (e.g., one of the examples 54 to 62) or to any of the examples described herein, further comprising that the first computer system is configured to communicate with the one or more second computer systems in peer-to-peer fashion.

An example (e.g., example 64) relates to a computer system (100b) comprising the device (10a) according to one of the examples 54 to 62.

An example (e.g., example 65) relates to a method for a first computer system (100a), the method comprising determining (110) a status of a firmware of the first computer system. The method comprises providing (120) information on the status of the firmware to one or more second computer systems. The method comprises obtaining (150) a response from at least one of the one or more second computer systems in response to the information on the status of the firmware.

Another example (e.g., example 66) relates to a previously described example (e.g., example 65) or to any of the examples described herein, further comprising that the method comprises providing information on the firmware being unbootable as part of the information on the status of the firmware if the firmware is determined to be unbootable.

Another example (e.g., example 67) relates to a previously described example (e.g., example 66) or to any of the examples described herein, further comprising that the method comprises obtaining a suitable firmware for the first computer system from the second computer system providing the response.

Another example (e.g., example 68) relates to a previously described example (e.g., example 67) or to any of the examples described herein, further comprising that the response comprises information on the second computer system offering to provide the suitable firmware for the first computer system, wherein the method comprises requesting (152) the suitable firmware from the second computer system based on the response.

Another example (e.g., example 69) relates to a previously described example (e.g., example 68) or to any of the examples described herein, further comprising that the response comprises the suitable firmware.

Another example (e.g., example 70) relates to a previously described example (e.g., one of the examples 65 to 69) or to any of the examples described herein, further comprising that the method comprises determining (112) a version information on the firmware of the first computer system, and to include (114) the version information in the information on the status of the firmware.

Another example (e.g., example 71) relates to a previously described example (e.g., example 70) or to any of the examples described herein, further comprising that the method comprises obtaining a firmware having an updated version for the first computer system from the second computer system providing the response.

Another example (e.g., example 72) relates to a previously described example (e.g., example 71) or to any of the examples described herein, further comprising that the response is obtained from at least one second computer system offering to provide the firmware having the updated version for the first computer system, wherein the method comprises requesting (152) the firmware having the updated version from the second computer system based on the response

Another example (e.g., example 73) relates to a previously described example (e.g., example 71) or to any of the examples described herein, further comprising that the response comprises the firmware having the updated version.

Another example (e.g., example 74) relates to a previously described example (e.g., one of the examples 65 to 73) or to any of the examples described herein, further comprising that the method comprises obtaining (130) information on the status of the firmware of the one or more second computer systems from the one or more second computer systems and providing (140) a further response to the one or more second computer systems based on the status of the firmware of the first computer system and based on the information on the status of the firmware of the one or more second computer systems.

Another example (e.g., example 75) relates to a previously described example (e.g., example 74) or to any of the examples described herein, further comprising that the method comprises determining (132), if the information on the status of the firmware of the one or more second computer systems indicates that the firmware of at least one second computer is determined to be unbootable, whether the first computer system comprises a firmware that is suitable for the at least one second computer, and providing (140. The method comprises 142) the suitable firmware to the at least one second computer if the first computer system comprises a firmware that is suitable for the at least one second computer system.

Another example (e.g., example 76) relates to a previously described example (e.g., example 75) or to any of the examples described herein, further comprising that the further response comprises information on the first computer system offering to provide the suitable firmware for the at least one second computer system, wherein the method comprises providing (142) the suitable firmware to the at least one second computer system upon request by the at least one second computer system.

Another example (e.g., example 77) relates to a previously described example (e.g., example 75) or to any of the examples described herein, further comprising that the further response comprises the suitable firmware.

Another example (e.g., example 78) relates to a previously described example (e.g., one of the examples 74 to 77) or to any of the examples described herein, further comprising that the method comprises determining a version information (112) on the firmware of the first computer system and comparing (134) the version information on the firmware of the first computer system with version information included in the information on the status of the firmware of the one or more second computer systems.

Another example (e.g., example 79) relates to a previously described example (e.g., example 78) or to any of the examples described herein, further comprising that the method comprises, if the first computer system comprises a firmware with an updated version relative to the version information included in the information on the status of the firmware of at least one of the one or more second computer systems, providing (140. The method comprises 142) the firmware having the updated version to the at least one second computer system.

Another example (e.g., example 80) relates to a previously described example (e.g., example 79) or to any of the examples described herein, further comprising that the further response comprises an offer to provide the firmware having the updated version to the at least one second computer system, and the method comprises providing (142) the firmware having the updated version upon request by the at least one second computer system.

Another example (e.g., example 81) relates to a previously described example (e.g., example 79) or to any of the examples described herein, further comprising that the further response comprises the firmware having the updated version.

Another example (e.g., example 82) relates to a previously described example (e.g., one of the examples 74 to 81) or to any of the examples described herein, further comprising that the first computer system comprises a repository with a plurality of firmware images, wherein the method comprises providing the further response to the one or more second computer systems based on the plurality of firmware images.

Another example (e.g., example 83) relates to a previously described example (e.g., one of the examples 65 to 82) or to any of the examples described herein, further comprising that the first computer system communicates with the one or more second computer systems in peer-to-peer fashion.

An example (e.g., example 84) relates to a computer system being configured to execute the method according to one of the examples 65 to 83.

An example (e.g., example 85) relates to a system comprising a plurality of computer systems according to example 84.

An example (e.g., example 86) relates to a method for a first computer system, the method comprising determining (110) a status of a firmware of the first computer system. The method comprises obtaining (130) information on the status of the firmware of the one or more second computer systems from the one or more second computer systems. The method comprises providing (140) a response to the one or more second computer systems based on the status of the firmware of the first computer system and based on the information on the status of the firmware of the one or more second computer systems.

Another example (e.g., example 87) relates to a previously described example (e.g., example 86) or to any of the examples described herein, further comprising that the method comprises determining (132), if the information on the status of the firmware of the one or more second computer systems indicates that the firmware of at least one second computer is determined to be unbootable, whether the first computer system comprises a firmware that is suitable for the at least one second computer, and providing (140. The method comprises 142) the suitable firmware to the at least one second computer if the first computer system comprises a firmware that is suitable for the at least one second computer system.

Another example (e.g., example 88) relates to a previously described example (e.g., example 87) or to any of the examples described herein, further comprising that the response comprises information on the first computer system offering to provide the suitable firmware for the at least one second computer system, wherein the method comprises providing (142) the suitable firmware to the at least one second computer system upon request by the at least one second computer system.

Another example (e.g., example 89) relates to a previously described example (e.g., example 87) or to any of the examples described herein, further comprising that the response comprises the suitable firmware.

Another example (e.g., example 90) relates to a previously described example (e.g., one of the examples 86 to 89) or to any of the examples described herein, further comprising that the method comprises determining (112) a version information on the firmware of the first computer system and comparing (134) the version information on the firmware of the first computer system with version information included in the information on the status of the firmware of the one or more second computer systems.

Another example (e.g., example 91) relates to a previously described example (e.g., example 90) or to any of the examples described herein, further comprising that the method comprises, if the first computer system comprises a firmware with an updated version relative to the version information included in the information on the status of the firmware of at least one of the one or more second computer systems, providing (140. The method comprises 142) the firmware having the updated version to the at least one second computer system.

Another example (e.g., example 92) relates to a previously described example (e.g., example 91) or to any of the examples described herein, further comprising that the response comprises an offer to provide the firmware having the updated version to the at least one second computer system, and the method comprises providing (142) the firmware having the updated version upon request by the at least one second computer system.

Another example (e.g., example 93) relates to a previously described example (e.g., example 91) or to any of the examples described herein, further comprising that the response comprises the firmware having the updated version.

Another example (e.g., example 94) relates to a previously described example (e.g., one of the examples 86 to 93) or to any of the examples described herein, further comprising that the first computer system comprises a repository with a plurality of firmware images, wherein the method comprises providing the response to the one or more second computer systems based on the plurality of firmware images.

Another example (e.g., example 95) relates to a previously described example (e.g., one of the examples 86 to 94) or to any of the examples described herein, further comprising that the first computer system communicates with the one or more second computer systems in peer-to-peer fashion.

An example (e.g., example 96) relates to a computer system (100b) being configured to perform the method according to one of the examples 86 to 95.

An example (e.g., example 97) relates to a machine-readable storage medium including program code, when executed, to cause a machine to perform the method of one of the examples 65 to 83 or the method according to one of the examples 86 to 95

An example (e.g., example 98) relates to a computer program having a program code for performing the method of one of the examples 65 to 83 or the method according to one of the examples 86 to 95 when the computer program is executed on a computer, a processor, or a programmable hardware component.

An example (e.g., example 99) relates to a machine-readable storage including machine readable instructions, when executed, to implement a method or realize an apparatus as claimed in any pending claim or shown in any example.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

Examples may further be or relate to a (computer) program including a program code to execute one or more of the above methods when the program is executed on a computer, processor, or other programmable hardware component. Thus, steps, operations, or processes of different ones of the methods described above may also be executed by programmed computers, processors, or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C #, Java, Perl, Python, JavaScript, Adobe Flash, C #, assembly language, or any other programming language. Likewise, the disclosed technologies are not limited to any particular computer system or type of hardware.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The disclosed methods, apparatuses, and systems are not to be construed as limiting in any way. Instead, the present disclosure is directed toward all novel and nonobvious features and aspects of the various disclosed embodiments, alone and in various combinations and subcombinations with one another. The disclosed methods, apparatuses, and systems are not limited to any specific aspect or feature or combination thereof, nor do the disclosed embodiments require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A non-transitory computer-readable medium storing instructions that, when executed by one or more processing circuitries, cause the one or more processing circuitries to perform a method for a first computer system, comprising:
determining a status of a firmware of the first computer system, wherein the status of the firmware of the first computer system comprises a version information;
providing information on the status of the firmware to the one or more second computer systems, the one or more second computer systems comprising local storage to store a suitable firmware for the first computer system; and
obtaining a response from at least one of the one or more second computer systems in response to the information on the status of the firmware, the response comprising information on the second computer system offering to provide the suitable firmware for the first computer system, and
request the suitable firmware stored by the second computer system from the second computer system providing the response based on the response, wherein the suitable firmware is obtained in peer-to-peer fashion.

2. The non-transitory computer-readable medium according to claim 1, wherein the method comprises determining the version information on the firmware of the first computer system, and including the version information in the information on the status of the firmware.

3. The non-transitory computer-readable medium according to claim 1, wherein the method comprises obtaining a firmware having an updated version for the first computer system from the second computer system providing the response.

4. The non-transitory computer-readable medium according to claim 3, wherein the response is obtained from at least one second computer system offering to provide the firmware having the updated version for the first computer system, wherein the method comprises requesting the firmware having the updated version from the second computer system based on the response.

5. The non-transitory computer-readable medium according to claim 1, wherein the first computer system is configured to communicate with the one or more second computer systems in peer-to-peer fashion.

6. A non-transitory computer-readable medium storing instructions that, when executed by one or more processing circuitries, cause the one or more processing circuitries to perform a method for a second computer system, comprising:
determining a status of a firmware stored by the first computer system in a local storage of the first computer system, wherein the status of the firmware of the first computer system comprises a version information;
obtaining information on the status of the firmware of one or more second computer systems from the one or more second computer systems, wherein the status of the firmware of the one or more second computer systems comprises a version information;
providing a response to the one or more second computer systems based on the status of the firmware stored by the first computer system and based on the information on the status of the firmware of the one or more second computer systems,
wherein the response comprises information on the first computer system offering to provide a suitable firmware for the at least one second computer system; and
providing the suitable firmware to the at least one second computer system upon request by the at least one second computer system, wherein the suitable firmware is provided in peer-to-peer fashion.

7. The non-transitory computer-readable medium according to claim 6, wherein the method comprises determining whether the first computer system comprises a firmware that is suitable for the at least one second computer system, and providing the suitable firmware to the at least one second computer if the first computer system comprises a firmware that is suitable for the at least one second computer system.

8. The non-transitory computer-readable medium according to claim 6, wherein the method comprises determining the version information on the firmware of the first computer system and comparing the version information on the firmware of the first computer system with the version information included in the information on the status of the firmware of the one or more second computer systems.

9. The non-transitory computer-readable medium according to claim 8, wherein the method comprises, if the first computer system comprises a firmware with an updated version relative to the version information included in the information on the status of the firmware of at least one of the one or more second computer systems, providing the firmware having the updated version to the at least one second computer system.

10. The non-transitory computer-readable medium according to claim 9, wherein the response comprises an offer to provide the firmware having the updated version to the at least one second computer system, and the method comprises providing the firmware having the updated version upon request by the at least one second computer system.

11. The non-transitory computer-readable medium according to claim 6, wherein the first computer system comprises a local storage with a plurality of firmware images, wherein the method comprises providing the response to the one or more second computer systems based on the plurality of firmware images.

12. The non-transitory computer-readable medium according to claim 6, wherein the first computer system communicates with the one or more second computer systems in peer-to-peer fashion.

13. A system comprising:
a first computer system, the first computer system comprising a first apparatus comprising:
interface circuitry for communicating with one or more second computer systems, and processing circuitry to:
determine a status of a firmware of the first computer system, wherein the status of the firmware of the first computer system comprises a version information;
provide information on the status of the firmware to the one or more second computer systems,
obtain a response from at least one of the one or more second computer systems in response to the information on the status of the firmware, the response comprising information on the second computer system offering to provide the suitable firmware for the first computer system, and
request the suitable firmware stored by the second computer system from the second computer system providing the response based on the response, wherein the suitable firmware is obtained in peer-to-peer fashion; and
a second computer systems comprising a second apparatus, the second apparatus comprising:
interface circuitry for communicating with the first computer system, and
processing circuitry to:
determine a status of a firmware stored by the second computer system in a local storage of the second computer system, wherein the status of the firmware of the second computer system comprises a version information,
obtain the information on the status of the firmware of the first computer system from the first computer system, wherein the status of the firmware of the first computer system comprises the version information;
provide the response to the first computer system based on the status of the firmware stored by the second computer system and based on the information on the status of the firmware of the first computer system, wherein the response comprises information on the second computer system offering to provide the suitable firmware for the first computer system; and
provide the suitable firmware to the first computer system upon request by the first computer system, wherein the suitable firmware is provided in peer-to-peer fashion.

14. The system according to claim 13, wherein the processing circuitry of the second apparatus is to determine whether the first computer system comprises a firmware that is suitable for the at least one second computer system, and provide the suitable firmware to the at least one second computer if the first computer system comprises a firmware that is suitable for the at least one second computer system.

15. The system according to claim 13, wherein the processing circuitry of the second apparatus is to determine the version information on the firmware stored by the second computer system and compare the version information on the firmware of the second computer system with the version information included in the information on the status of the firmware of the first computer system.

16. The system according to claim 13, wherein the processing circuitry of the second apparatus is to, if the first computer system comprises a firmware with an updated version relative to the version information included in the information on the status of the firmware of at least one of the one or more second computer systems, provide the firmware having the updated version to the at least one second computer system.

17. The system according to claim 13, wherein the second computer system comprises a local storage with a plurality of firmware images, wherein the processing circuitry of the second apparatus is to provide the response to the first computer system based on the plurality of firmware images.

18. The system according to claim 13, wherein the processing circuitry of the first apparatus is to obtain a firmware having an updated version for the first computer system from the second computer system providing the response.

19. The system according to claim 13, wherein the response is obtained from at least one second computer system offering to provide the firmware having the updated version for the first computer system, wherein the processing circuitry of the first apparatus is to request the firmware having the updated version from the second computer system based on the response.
